(19) United States
(12) Patent Application Publication
(10) Pub. No.: US 2015/0189058 A1
(43) Pub. Date: Jul. 2, 2015

(54) SMART CASE FOR MOBILE PHONE HAVING RECORDING FUNCTION

(71) Applicant: KyoungMin HWANG, (US)

(72) Inventor: KyoungMin Hwang, Gyeonggi-do (KR)

(21) Appl. No.: 14/408,646

(22) PCT Filed: Jun. 14, 2013
(86) PCT No.: PCT/KR2013/005295

§ 371 Date: Dec. 17, 2014

(30) Foreign Application Priority Data
Jun. 18, 2012 (KR) 10-2012-0065210

(51) Int. Cl. H04M 1/656; H04B 1/3888; H04M 1/725

(52) U.S. Cl. CPC H04M 1/656; H04M 1/72575; H04B 1/3888

(57) ABSTRACT

The present invention is a smart case for a mobile phone made of plastic, metal, a synthetic resin, and/or synthetic rubber. The smart case has multiple necessary through-holes arranged as appropriate, an input microphone and an output speaker arranged and inserted in the smart case such that the input microphone and the output speaker are matched with or correspond to a sending unit and a receiving unit of a mobile phone to be accommodated in the smart case, and a wire penetrating unit, a protrusion, or the like which is connectable to a recorder device. The smart case accommodates the recorder device which comprises, as a storage medium, an external memory card having an operating button. The smart case receives the power required for operating the recorder device through a connector of the mobile phone using a connector extension power plug. The smart case enables a mobile phone charger/PC data transceiving cable to be connected thereto through an extension connector unit when the smart case is firmly coupled to the mobile phone.

### CROSS-REFERENCE TO RELATED APPLICATION

This application is a National phase of PCT patent Application No. PCT/KR2013/005295 having an International filing date of Jun. 14, 2013, which claims priority to Korean Patent Application No. 10-2012-0065210, filed on Jun. 18, 2012, the entireties of which are incorporated herein by reference.

### FIELD OF THE INVENTION

The present invention relates to a mobile phone case having a recording function, and in particular to a structure combined with a member for a recording function and a communication recording function of a mobile phone itself, a recording system configured to enhance efficiency when in use with respect to a mobile phone whose way of use is not intuitive, a mobile phone protection case and a creative electric power system.

### BACKGROUND OF THE INVENTION

For a smart phone which is available in recent years, it seems that such a smart phone continuously advances for the sake of user's conveniences based on a system wherein many software, etc. may be used from a convenient hardware feature such as a touch screen, etc.

A recording function which looks like it is not related with such a technology development direction and we have long used among old and convenient functions may be recognized as a relatively representative function which is built in most of mobile phones since when the products are first launched.

Furthermore, an enterprise such as a Samsung among many enterprises which manufacture global smart phones aims to promote the convenience when the local people use in such a way to build a recording function during the communication into an instrument since when the products are launched.

However, the manufacturing enterprises of the mobile phones of which the head offices are located overseas like Apple manufacturing iPhone series don't provide the recording function during the communication.

The reason for the above feature is that part of the US states where Apple manufacturing iPhone series is located restricts the recording of the communication without consents from opponents by Communication Act.

Even though there are not any problems in building in the recording function during the communication in compliance with the local Communication Act among the enterprises which manufacture global smart phones because there are not many regulation target countries such as Communication Act throughout the world, such global smart phones are generally exported with the recording function removed.

The users in the countries where such functions are relatively free from Communication Act attempt to change the devices due to the absence of the necessarily representative functions, which cause a lot of over consumption in terms of opportunity cost while causing a secondary social problem such as hacking the devices, etc.

In order to overcome such problems, a recording function software is separately developed and is often launched, but very few. Complicated procedures and many fare loads when in use may become a serious problem between the developing direction of the technology for the future and the systematic aspects.

### BRIEF DESCRIPTION OF DRAWINGS

FIG. 1A is a perspective view illustrating a state where a smart case and a mobile phone are separated according to an exemplary embodiment of the present invention.

FIG. 2A is a perspective view illustrating a state where a smart case is separated according to an exemplary embodiment of the present invention.

FIG. 3A is a perspective view illustrating an arrangement of a microphone and a speaker based on an accommodation target mobile phone in a smart case according to an exemplary embodiment of the present invention.

FIG. 4A is a lower perspective view illustrating an engagement of a sound input and output system and a recording device in a smart case according to an exemplary embodiment of the present invention.

FIG. 5A is a left side view illustrating a docking state and an enlarged state of a recording device and a connector extension power plug in a smart case according to an exemplary embodiment of the present invention.

FIG. 6A is a perspective view illustrating an enlarged state of two connector extension power plugs according to an exemplary embodiment of the present invention.

FIG. 7A is a perspective view illustrating an exemplary engaging procedure of a smart case and a mobile phone according to an exemplary embodiment of the present invention.

FIG. 7B is a perspective view illustrating an engaging state of a smart case and a mobile phone according to an exemplary embodiment of the present invention.

*Legend of Reference Numbers of Major Components of the Drawings*

| | |
|---|---|
| 11: mobile phone body | 13: mobile phone connector |
| 16: mobile phone transmitter | 17: mobile phone receiver |
| 21: smart case body | 22: necessary through hole |
| 31: recording device | 33: recording device power terminal |
| 34: recording device operation button | 36: sound grill passing- through unit |
| 37: recording device display unit | 38: recording device memory card insertion unit |
| 41: sound input and output system | 42: first input microphone |
| 43: second input microphone | 44: output speaker |

45: sound input and output system wiring

| | |
|---|---|
| 51: connector extension power plug | 53: connector extension power plug electrode plate |
| 54: protrusion insertion terminal | 55: concave accommodation terminal |
| 56: extension connector | 59: connector extension power plug insertion unit |
| 61: universal memory card | 69: memory card insertion unit |

71: screw nail

### DETAILED DESCRIPTION OF THE INVENTION

Accordingly, the present invention is made in an effort to resolve the problems in the conventional mobile phones and to maximize the convenience and efficiency when in use. It is an object of the present invention to provide a smart case for a mobile phone having a recording function which is characterized in that a smart case for the same is manufactured like a case based on the exterior of an accommodation target mobile phone for thereby protecting a mobile phone having a relatively expensive value, and it is possible to increase efficiency by adding a typical recording function and a recoding function during the communication without causing any problems in the natural functions of the mobile phone such as a data transceiving operation between the mobile phone and the personal computer and a connection of a charging cable of the mobile phone, etc.

To achieve the above objects, there is provided a smart case for a mobile phone which is characterized in that there is provided a structural body made from one among plastic, metal, synthetic resin and resin rubber, and
there are provided a plurality of through holes which are necessary for the use of the cellular phone, and
an input microphone and an output speaker are arranged and inserted at a position combined with or corresponding to a transmission unit and a receiving unit of the accommodation object cellular phone, and there are provided a passing-through unit and a protrusion in which wiring is possible, and
an external memory card is provided as a storing medium, and a recording device having an operation button is accommodated, and
an electric power necessary for the operation of a recording device is obtained using a connector of a mobile phone, and there is provided an additional system which allows a mobile phone connector to extend to the outside so as to maintain functions such as a charging function of a mobile phone and a data communication with a personal computer.

### Advantageous Effects

The smart case for a mobile phone having a recording function according to the present invention has,
an external impact absorbing effect and a damage and destroy prevention effect due to a user's careless behavior in a state where a mobile phone is accommodated, and
a much quicker voice recording and communication recording are available and a data management is easy with the aid of an intuitive operation of a button unit exposed on the surface of the top and a display unit, and
since a recording device which does not need any power for the operation of a charger, etc., any instable factor which might occur due to the discharge of the power is eliminated, so reliability for data storing may be enhanced, and
in case of a data transceiving operation between the mobile phone and the personal computer and when connecting a charging cable of the mobile phone, there are not any inconvenience when separating the case for the mobile phone and any damages to the device due to the frequent detachment, and
in case of the damages at the connection portion of the connector which might frequently occur due to the characteristics of the device, an additional maintenance cost due to the tolerance of the device is less since a separable connector extension power plug is used, and
since an additional universal storing medium is used, the device is compatible with various devices such as a computer, and a data managing ability may be enhanced, and a data protection ability may be maximized when there is a concern due to the damages to the device.

### Mode for Invention

The exemplary embodiments of the present invention will be described with reference to the accompanying drawings.

The accompanying drawings are not made based on the scale, and the same reference numbers in each drawing represent the same components.

In addition, if it is judged that the detailed descriptions on the related construction or function may make unclear the gist of the present invention in the course of the descriptions of the present invention, such detailed descriptions may be omitted.

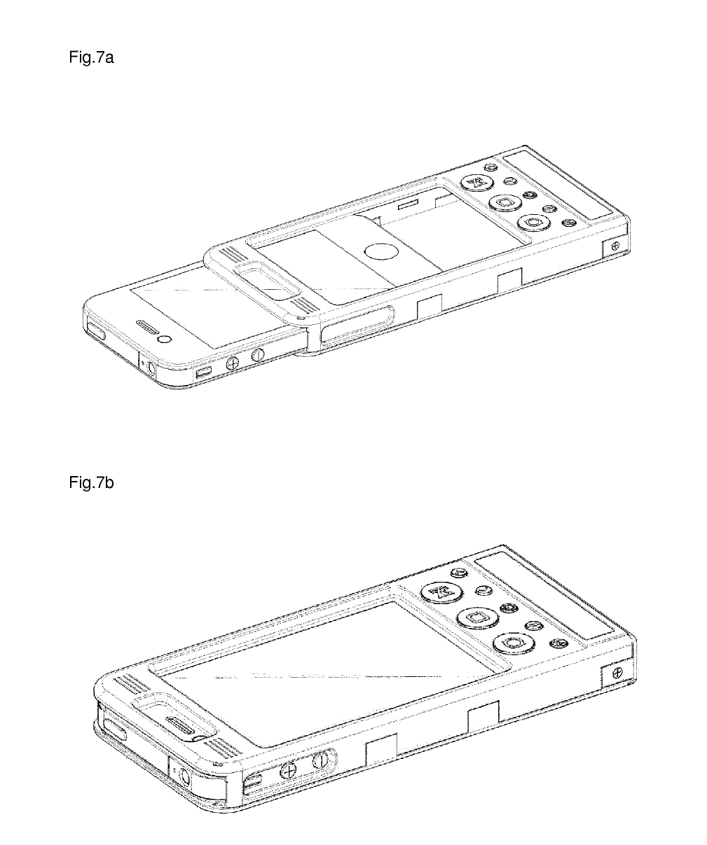

First, while accommodating the mobile phone as a rectangular structure of which one side is open as illustrated in FIG. 7A, the connector extension power plug 51 as illustrated in FIG. 1A is inserted in the insertion unit 59 of the smart case 21 and at the same time is inserted in the mobile phone connector 13 for thereby forming an electrical engagement, and

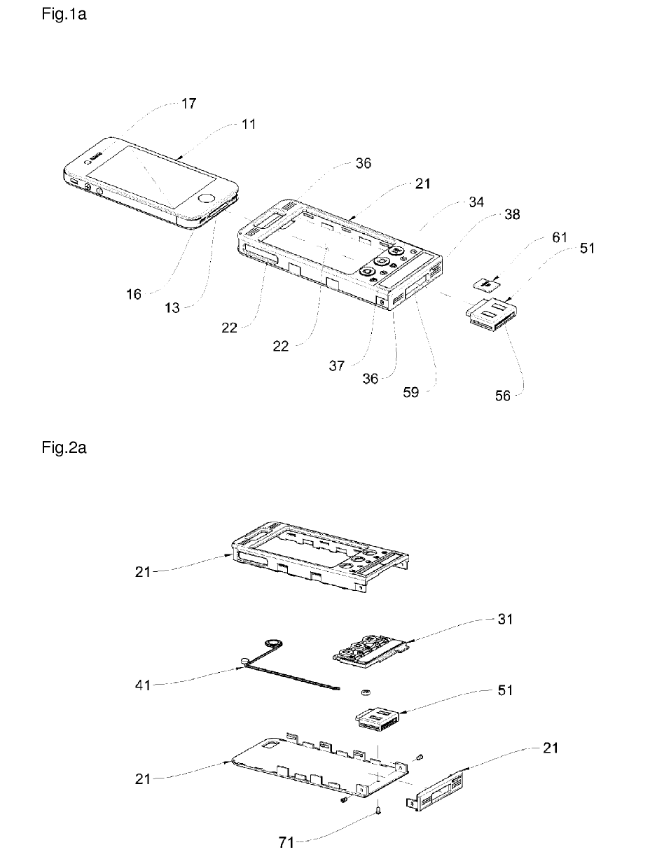

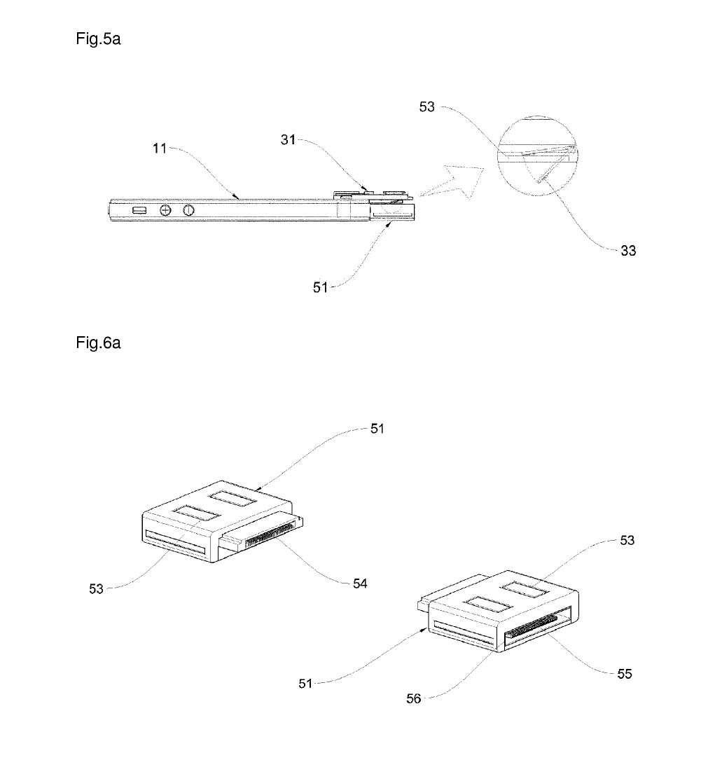

As illustrated in FIG. 5A, an operable power of the recording device 31 is generated based on a sliding contact between the power terminal 33 disposed at one side of the bottom of the recording device 31 and the electrode plate 53 disposed at the top of the connector extension power plug 51, so that it is possible to secure an electrically stable engagement state between the mobile phone body 11 and the smart case 21, and as illustrated in FIG. 2A, a physically stable engagement state may be also secured using a screw nail 71.

More specifically, the connector extension power plug 51, as illustrated in FIG. 6A, is constituted in one structural body wherein the protrusion insertion terminal 54 corresponds to the concave accommodation terminal 55 of the extension connector 56, and the electrode plate 53 is disposed at an outer surface of one side.

In addition, as illustrated in FIG. 1A, when the engagement between the mobile phone body 11 and the smart case 21 is completed, the mobile phone connector 13 is extended through the connector extension power plug 51 to the outer surface of the case while being exposed for the sake of the connection of the mobile phone charging-PC data transceiving cable.

When taking a look at the exterior of the smart case 21 as illustrated in FIG. 1A, there are provided a plurality of necessary through holes 22 formed in consideration of the exposing portions when the mobile phone is used, the connector extension power plug insertion unit 59, and the memory card insertion unit 69.

When taking a look at the recording device 31 inserted in the smart case 21 as illustrated in FIGS. 1A, 4A and 7B, the recording device 31 includes a recording device power terminal 33, an operation button 34 formed of a recording button, a playback button and a menu button which are necessary for the operations of the device such as a recording, etc. wherein the individual level adjusting of the power switch and the sound input and output system are possible, a LCD display unit 37 configured to easily check the data states, a sound grill passing-through unit 36 which is necessary for the communication of the accommodation target mobile phone body 11 and the data listening, and a recording device memory card insertion unit 38 which is necessary when storing the data, but such a recording device 31 does not include a battery insertion unit such as an additional charger, etc.

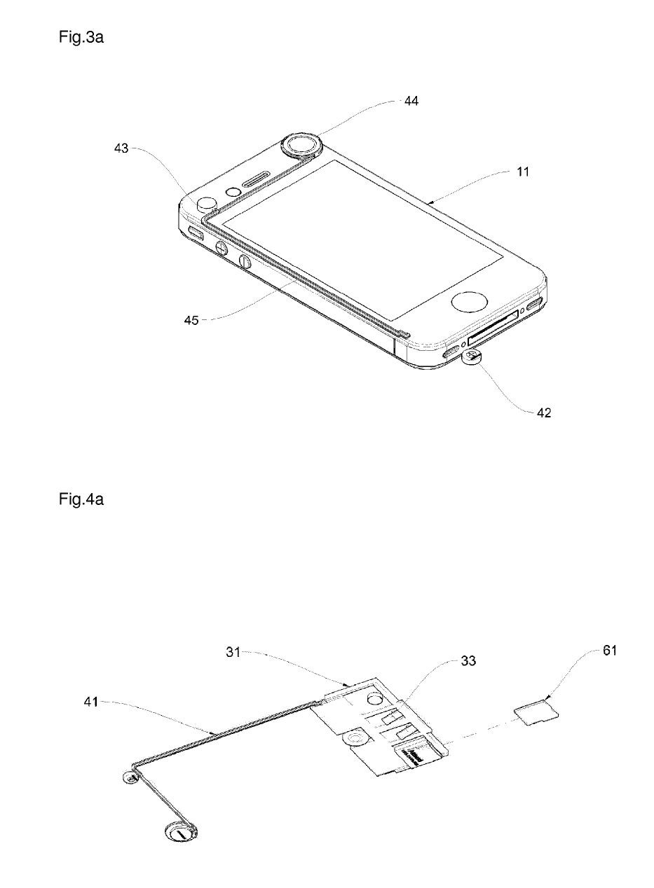

In addition, as illustrated in FIG. 4A, the arrangement of the sound input and output system 41 connected to the recording device 31 will be described in more details. As illustrated in FIGS. 3A and 4A, the configuration looks like one system wherein the first input microphone 42 combined with the accommodation target mobile phone transmitter 16, the second input microphone 43 corresponding to the accommodation target mobile phone receiver 17 and the combining output speaker 44 is arranged and inserted, and a wiring 45 of the input and output system is provided for the sake of a connection between the input and output system and the recording device 31.

The omitted contents in the descriptions of the present invention having such configurations may be modified, so they should be interpreted to be included in the scope of the claims of the present invention.

For example, a method for a locking device configured to make stable the accommodation state or an alternative way to increase the friction coefficient against the mobile phone accommodation surface inside of the case or a way to change the kinds of the universal storing memory card 61 or the specification and design of the recording device in the conventional art which are low and universalized, are not illustrated, but such methods and ways are also available in the present invention.

The above descriptions are provided for illustrative purposes of the technical concepts of the present invention, and it is obvious that a person having ordinary skill in the art may variously modify and change without departing from the natural characteristics of the present invention.

Therefore, the exemplary embodiments disclosed in the present invention are provided for the sake of descriptions, not limiting the technical concepts of the present invention, and it should be understood that such exemplary embodiments are not intended to limit the scope of the technical concepts of the present invention.

The protection scope of the present invention should be understood by the claims below, and all the technical concepts within the equivalent scopes should be interpreted to be within the scope of the right of the present invention.

We claim:

1. A detachable smart case for a mobile phone having an outside sound recording function and a communication content recording function, comprising:
a smart phone case body 21 configured to accommodate a mobile phone;
a recording device 31 which is accommodated and assembled inside of the smart case body 21 and is electrically connected with a mobile phone connector 13 and is configured to receive electric power;
a detachable connector extension power plug 51 wherein a protrusion insertion terminal 54 and a concave accommodation terminal 55 inserted in the mobile phone connector 13 correspond to each other, and an electrode plate 53 is disposed at an outer surface of one side; and
an extension connector 56 which extends up to an outer surface of the smart case 21, wherein an electrode plate 53 of the connector extension power plug 51 slide-contacts with a power terminal 33 disposed at one side of the bottom surface of the recording device 51 for thereby obtaining electric power of the recording device 51, and
in a state where the engagement of the mobile phone body 11 and the smart case 21 is maintained, a connection of a mobile phone charging-PC data transceiving cable is available using the extension connector 56.

2. The case of claim 1, wherein the mobile phone smart case is one structure body made from at least one among plastic, metal, synthetic resin and synthetic rubber and includes a plurality of through holes 22 which are necessary for the uses of the accommodation unit of the mobile phone body 11, the insertion units of the recording device 31 and the sound input and output system 41, the extension connector 56, the memory card insertion unit 69, the mobile phone body 11 and the recording device 31.

3. The case of claim 2, wherein the recording device is connected with a sound input and output system 41 which includes a first input microphone 42 configured in combination with a mobile phone transmitter 16, a second input microphone 43 which corresponds to a mobile phone receiver 17, an output speaker 44 configured in combination with the mobile phone receiver 17, and a wiring 45 connected to the input microphone and the output speaker, and the recording device includes an adjusting unit and operation button unit 34 configured for the adjustments of individual input and output levels, a display unit 37, an electric power terminal 33 corresponding to the connector extension power plug electrode plate 53, and an external type memory card insertion unit 38, wherein the recording device is operable by using only a mobile phone electric power.
